(19) United States
(12) Patent Application Publication
(10) Pub. No.: US 2020/0186887 A1
(43) Pub. Date: Jun. 11, 2020

(54) REAL-TIME BROADCAST EDITING SYSTEM AND METHOD

(71) Applicant: STARSHIP VENDING-MACHINE CORP., Seoul (KR)

(72) Inventors: Ji Yong KWON, Seoul (KR); Su Young JEON, Seoul (KR)

(73) Assignee: STARSHIP VENDING-MACHINE CORP., Seoul (KR)

(21) Appl. No.: 16/722,718

(22) Filed: Dec. 20, 2019

Related U.S. Application Data
(63) Continuation of application No. PCT/KR2019/009580, filed on Jul. 31, 2019.

(30) Foreign Application Priority Data
Dec. 7, 2018 (KR) 10-2018-0157173

(51) Int. Cl. H04N 21/472; H04N 21/2743; H04N 21/6437; H04N 21/2343

(52) U.S. Cl. CPC H04N 21/47205; H04N 21/2343; H04N 21/6437; H04N 21/2743

(57) ABSTRACT

Disclosed is a system for editing a broadcast in real time and an editing method therefor. The method includes receiving a plurality of video streams from a plurality of mobile terminals through a first streaming server; displaying the plurality of video streams being received on a preview area of a display; receiving a first user input for selecting at least one of the plurality of video streams displayed on the preview area; and displaying a user interface for editing a broadcast screen on an editing area of the display; receiving a second user input via the user interface; editing the selected at least one video stream based the first user input and the second user input, thereby generating an edited broadcast video stream; displaying the edited broadcast video stream on a broadcast screen area of the display; and transmitting the edited broadcast video stream to a second streaming server.

### CROSS-REFERENCE TO RELATED APPLICATIONS

The present application is a continuation of International Patent Application No. PCT/KR2019/009580, filed Jul. 31, 2019, which is based upon and claims the benefit of priority to Korean Patent Application No. 10-2018-0157173, filed on Dec. 7, 2018. The disclosures of the above-listed applications are hereby incorporated by reference herein in their entirety.

### TECHNICAL FIELD

The present disclosure relates to a system for editing a broadcast in real time and an editing method therefor, and more specifically, to a broadcast editing system and method capable of easily producing broadcast content by receiving video streams from a plurality of external devices and editing the received video streams in real time and capable of providing a broadcast in real time.

### BACKGROUND OF THE INVENTION

Recently, with developments in Internet technology, the personal broadcast content market is gradually growing. In addition, unlike the past, where videos were accessed through televisions or computers, video contents viewable through mobile devices are explosively increasing with developments in mobile devices. Accordingly, an environment where an individual provides a broadcast through a mobile device is being constructed, and the influence of personal broadcasting on the broadcasting market is gradually increasing.

In general, broadcasting using a mobile device has a structure in which video data and speech data are recorded using a camera and a microphone mounted on the mobile device and are transmitted to multiple viewers through a streaming server such that viewers may watch the broadcast. As such, the broadcast content is produced only using a single camera screen and single speech data due to the physical limitations of the mobile device, which makes it difficult to secure various contents.

### DISCLOSURE

### Technical Problem

Embodiments disclosed in the present disclosure relate to a broadcast editing system and method that are capable of producing professional-level broadcast content by displaying a plurality of videos, which are captured by a plurality of external devices, together on a broadcast screen and allowing a screen shift between videos, various screen arrangements, and various types of editing to be performed in real time, and capable of providing a broadcast in real time.

### Technical Solution

According to an embodiment of the present disclosure, a real-time broadcast editing method includes receiving a plurality of video streams from a plurality of mobile terminals through a first streaming server; displaying the plurality of video streams being received on a preview area of a display; receiving a first user input for selecting at least one of the plurality of video streams displayed on the preview area; and displaying a user interface for editing a broadcast screen on an editing area of the display; receiving a second user input via the user interface; editing the selected at least one video stream based the first user input and the second user input, thereby generating an edited broadcast video stream; displaying the edited broadcast video stream on a broadcast screen area of the display; and transmitting the edited broadcast video stream to a second streaming server. The first streaming server has a streaming delay time less than a streaming delay time of the second streaming server, and the edited broadcast video stream is provided to a plurality of viewing terminals by the second streaming server.

The editing of the selected at least one video stream based on the first user input and the second user input, thereby generating the edited broadcast video stream includes generating a broadcast video stream based on the first user input; displaying the broadcast video stream on the broadcast screen area of the display; and editing the broadcast video stream based on the second user input, thereby generating the edited broadcast video stream.

The first streaming server is a Web Real-Time Communication (WebRTC) based streaming server, and the second streaming server is a Real Time Messaging Protocol (RTMP) based streaming server. The second streaming server converts the edited broadcast video stream using HTTP Live Streaming (HLS) or MPEG Dynamic Adaptive Streaming over HTTP (MPEG-DASH) and provides the converted edited broadcast video stream to the plurality of viewing terminals.

Qualities of the plurality of video streams received from the plurality of mobile terminals are determined based on the first user input. The video stream selected by the first user input is received at an increased quality level. The video stream not selected by the first user input is received at an decreased quality level.

The generating of the broadcast video stream based on the first user input includes determining a layout in which the video streams selected by the first user input are arranged; determining quality of each of the selected video streams based on an area ratio occupied by each video stream in the layout; and receiving the selected video streams with the determined respective qualities from the plurality of mobile terminals and generating a broadcast video stream according to the layout.

The editing of the broadcast video stream includes at least one of changing a layout in which the selected video streams are arranged; inserting a subtitle into the broadcast video stream; inserting an image into the broadcast video stream; inserting a video into the broadcast video stream; inserting sound into the broadcast video stream; and applying a filter to the broadcast video stream.

The preview area, the broadcast screen area, and the editing area are displayed together on the display; and the selected video stream is displayed on the broadcast screen area and not displayed on the preview area.

According to an embodiment of the present disclosure, a real-time broadcast editing system includes a data receiver configured to receive a plurality of video streams from a plurality of mobile terminals through a first streaming server; a display configured to display a preview area, a broadcast screen area, and an editing area; an input device configured to receive a user input; a controller configured to generate a broadcast video stream and edit the generated broadcast video stream; and a data transmitter configured to transmit the edited broadcast video stream to a second streaming server. The controller is configured to display the plurality of video streams being received on the preview area; receive a first user input for selecting at least one of the plurality of video streams displayed on the preview area; display a user interface for editing a broadcast screen on the editing area; receive a second user input, which is input via the user interface, from the input device; edit the selected at least one video stream based on the first user input and the second user input and generate an edited broadcast video stream; and display the edited broadcast video stream on the broadcast screen area. The first streaming server has a streaming delay time less than a streaming delay time of the second streaming server, and the edited broadcast video stream is provided to a plurality of viewing terminals by the second streaming server.

### Advantageous Effect

According to various embodiments of the present disclosure, broadcast content may be easily produced and various broadcast contents may be generated by providing a editing system and method capable of editing videos captured by a plurality of external devices in real time. By using a plurality of mobile devices, directing effects at a level similar to that of a general television broadcast can be expected, and a new level of mobile video content, such as a teleconference and personal live broadcasts from all parts of the country, can be produced. In addition, by replacing expensive Electronic News Gathering (ENG) cameras with mobile devices, the broadcast production cost may be reduced, and video production becomes approachable to everyone, thereby creating an environment in which various types of digital content may be generated.

It should be understood that the effects of the present disclosure are not limited to the above effects, and other effects not described herein may become apparent to those of ordinary skill in the art based on the scope of claims.

### DESCRIPTION OF DRAWINGS

Embodiments of the present disclosure will be described with reference to the accompanying drawings, where like reference numerals denote similar elements, but are not limited thereto.

FIG. 1 illustrates an environment where a real-time broadcast is produced/edited and is transmitted using a real-time broadcast editing apparatus according to an embodiment of the present disclosure.

FIG. 2 is a block diagram illustrating a detailed configuration of the real-time broadcast editing apparatus according to an embodiment of the present disclosure.

FIG. 3 is a flowchart showing a real-time broadcast editing method according to an embodiment of the present disclosure.

FIG. 4 is a view illustrating an example of real-time broadcast editing according to an embodiment of the present disclosure.

FIG. 5 is a diagram illustrating an example of real-time broadcast editing according to another embodiment of the present disclosure.

FIG. 6 is a view illustrating an example of real-time broadcast editing according to another embodiment of the present disclosure.

FIG. 7 is a view illustrating an example in which the layout of the broadcast video stream is changed using a user interface according to an embodiment of the present disclosure.

FIG. 8 is a view illustrating an example in which a screen of a video stream is enlarged using a user interface according to an embodiment of the present disclosure.

FIG. 9 is a diagram illustrating an example in which an object included in a video stream is corrected using a user interface according to an embodiment of the present disclosure.

FIG. 10 is a diagram illustrating an example in which graphic elements are synthesized into a video stream using a user interface according to an embodiment of the present disclosure.

FIG. 11 is a view illustrating an example in which a filter is applied to a video stream using a user interface according to an embodiment of the present disclosure.

### DETAILED DESCRIPTION OF THE PRESENT INVENTION

Hereinafter, embodiments of the present disclosure will be described in detail with reference to the accompanying drawings. In the description of the present disclosure, detailed descriptions of related known functions or constructions will be omitted to avoid obscuring the subject matter of the present disclosure.

Before describing the embodiments of the present disclosure, it should be noted that an upper part of a drawing may be referred to as an “upper portion” or “upper side” of an element shown in the drawing, and a lower part of the drawing may be referred to as a “lower portion” or “lower side” of the element. In addition, the remaining portion of the element between the upper portion and the lower portion or except for the upper portion and the lower portion may be referred to as a “side portion” or “side surface”.

In the accompanying drawings, parts that are identical or equivalent to each other will be assigned the same reference numerals, and in the following description of the embodiments, details of redundant descriptions thereof will be omitted. However, such an omission of some parts does not intend to exclude the parts in a certain embodiment. The relative terms, such as “upper portion” and “upper side,” may be used to describe the relationship between elements shown in the drawing, and the present disclosure is not limited by the terms.

In the present disclosure, “video stream” may refer to consecutive audio and video data blocks that are transmitted and received by electronic devices over a communication network, such as the Internet. In the present disclosure, “broadcast video stream” may refer to a video stream generated by combining/rendering a plurality of video streams being received from a plurality of mobile terminals using a real-time broadcast editing apparatus.

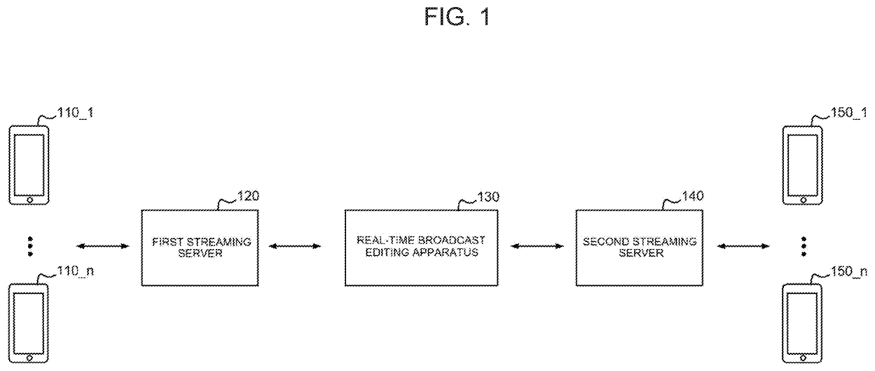

FIG. 1 illustrates an environment where a real-time broadcast is produced/edited and is transmitted using a real-time broadcast editing apparatus 130 according to an embodiment of the present disclosure. A plurality of mobile terminals 110_1 to 110_n may each transmit a video steam to the real-time broadcast editing apparatus 130 through a first streaming server 120. The mobile terminals 110_1 to 110_n may transmit video streams captured using a camera module (not shown) and a microphone module (not shown) in real time. Alternatively, the mobile terminals 110_1 to 110_n may transmit videos stored in internal storage thereof to the real-time broadcast editing apparatus 130 through the first streaming server 120.

In one embodiment, the mobile terminals 110_1 to 110_n may include a smart phone, a tablet personal computer (PC), a laptop, a personal digital assistant (PDA), a mobile communication terminal, and the like but are not limited thereto, and may be any device having a camera module and/or a communication module. The real-time broadcast editing apparatus 130 may be an electronic device having a communication module which enables a network connection and configured to edit and render a video. For example, the real-time broadcast editing apparatus 130 may be a mobile terminal, such as a smart phone, a laptop, a tablet PC, or the like, or may be a fixed terminal such as a desktop PC.

The first streaming server 120 may be configured to provide the video streams received from the mobile terminals 110_1 to 110_n to the real-time broadcast editing apparatus 130. In order to minimize delays of video signals and audio signals captured by the mobile terminals 110_1 to 110_n, the first streaming server 120 may be implemented as a server using an video transmission/reception protocol having a short delay time. For example, the first streaming server 120 may be a Web Real-Time Communication (WebRTC) based streaming server. Alternatively, the mobile terminals 110_1 to 110_n and the real-time broadcast editing apparatus 130 may be connected through an internal network such that the mobile terminals 110_1 to 110_n directly transmit the video streams to the real-time broadcast editing apparatus 130.

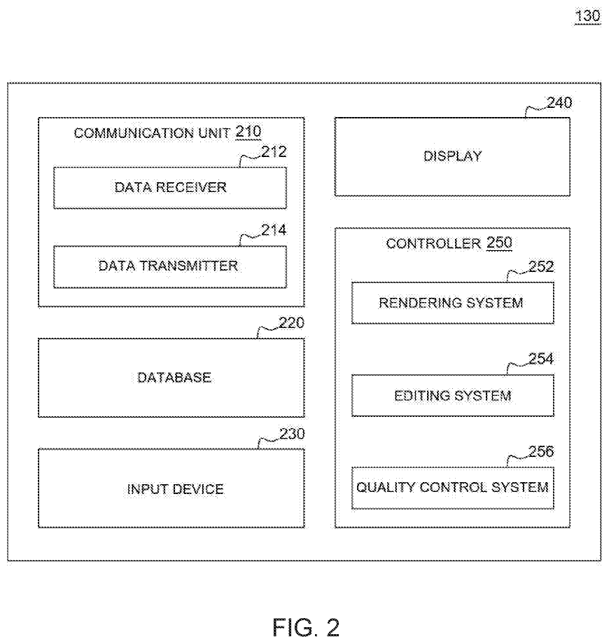

The real-time broadcast editing apparatus 130 may receive at least one video stream from the first streaming server 120 through a communication network and arrange some or all of the received video streams on a screen to generate a broadcast video stream. In addition, the real-time broadcast editing apparatus 130 may edit the generated broadcast video stream and provide the edited broadcast video stream to a plurality of viewing terminals 150_1 to 150_n through a second streaming server 140. The process of the real-time broadcast editing apparatus 130 receiving a plurality of video streams and generating/rendering a broadcast video stream and an edited broadcast video stream will be described in detail with reference to FIGS. 2 to 11.

In one embodiment, the second streaming server 140 may be a streaming server suitable for providing streaming services to a large number of users. For example, the second streaming server 140 may be a Real Time Messaging Protocol (RTMP) based streaming server. Since the first streaming server 120 receives video streams from a small number of users and delivers the video streams to the real-time broadcast editing apparatus 130 while the second streaming server 140 provides streaming services to a large number of users, the first streaming server 120 may be configured to have a streaming delay time shorter than that of the second streaming server 140. For example, the streaming delay time of the first streaming server 120 may be within 0.5 seconds, and the streaming delay time of the second streaming server 140 may be about 5 seconds.

In one embodiment, the second streaming server 140 converts an edited broadcast video stream received from the real-time broadcast editing apparatus 130 using a protocol such as HTTP Live Streaming (HLS), MPEG Dynamic Adaptive Streaming over HTTP (MPEG-DASH), or the like, which is capable of providing a large number of users with broadcast video streams, to provide the plurality of viewing terminals 150_1 to 150_n with the edited broadcast video streams.

FIG. 2 is a block diagram illustrating a detailed configuration of the real-time broadcast editing apparatus 130 according to an embodiment of the present disclosure. As shown in FIG. 2, the real-time broadcast editing apparatus 130 may include a communication unit 210, a database 220, an input device 230, a display 240, and a control unit 250. The communication unit 210 may communicate with an external device, such as a user terminal or a server, through a communication network and may include a data receiving unit 212 and a data transmitting unit 214.

According to one embodiment, the data receiving unit 212 may receive at least one video stream from a plurality of mobile terminals, and the video stream being received may be rendered/edited by the control unit 250 and then provided to a plurality of viewing terminals by the data transmitting unit 214. In detail, the data receiving unit 212 may communicate with the first streaming server to receive a plurality of video streams from the plurality of mobile terminals and provide the control unit 250 with the plurality of video streams being received. The control unit 250 may simultaneously output the plurality of received video streams on the display 240 to provide a user with the plurality of video streams being received. In one embodiment, the control unit 250 may store the video streams being received in the database 220.

The control unit 250 may include a rendering system 252, an editing system 254, and a quality control system 256. The control unit 250 may display the plurality of video streams being received in a preview area of the display 240. The preview area is an area displayed on the display 240 to provide the plurality of video stream being received to a user in real time.

Among the video streams displayed on the preview area, the user may select at least one video stream to be broadcast to a viewer terminal via the input device 230. The input device 230 may be, for example, a touch display, a keyboard, a mouse, a touch pen, a stylus, a microphone, a motion recognition sensor, or the like, but is not limited thereto. When the control unit 250 receives a user input for selecting a video stream to be broadcast to the viewer terminal from the input device 230, the rendering system 252 arranges the selected video streams on a screen according to a predetermined layout to generate/render a broadcast video stream. The generated/rendered broadcast video stream may be displayed on a broadcast screen area of the display 240.

In one embodiment, a preview area, a broadcast screen area, and an editing area may be displayed together on the display 240. The editing area is an area in which a user interface for editing a broadcast screen/broadcast video stream is displayed. When a user wishes to edit a broadcast screen/broadcast video stream displayed on the broadcast screen area, the user may edit the broadcast screen/broadcast video stream using the user interface displayed on the editing area.

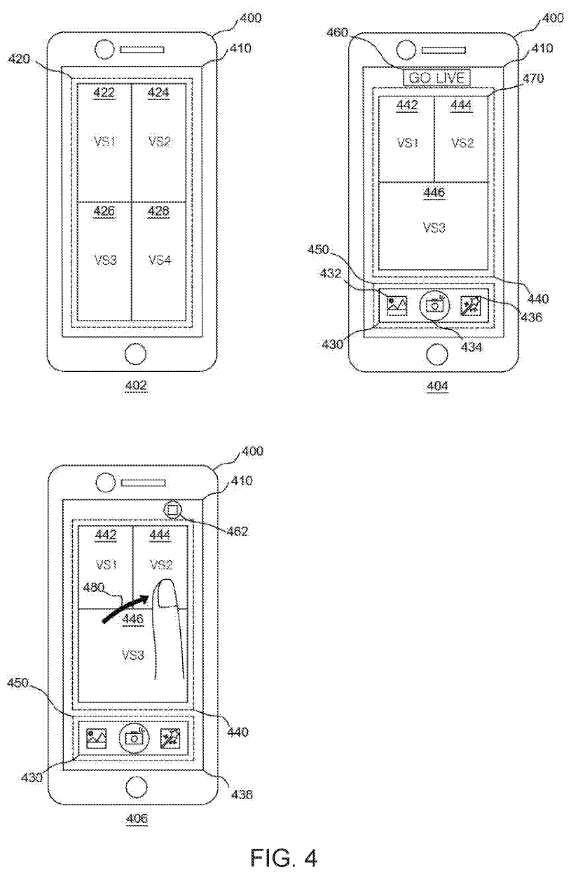

In detail, the editing system 254 may edit the broadcast video stream in various ways, such as changing the layout of the broadcast screen, inserting subtitles, inserting images, inserting videos, inserting sounds, applying filters, and the like based on a user input that is input via the input device 230. The control unit 250 may display the edited broadcast video stream on the broadcast screen area of the display 240 such that the user is provided with the edited video in real time. In addition, the edited broadcast video stream may be transmitted to the second streaming server by the data transmitting unit 214 and may be broadcast to a plurality of viewing terminals. An example in which the editing system 254 edits the broadcast video stream will be described in detail with reference to FIGS. 4 to 10.

The quality control system 256 may adaptively control the qualities of a plurality of video streams received by the real-time broadcast editing apparatus 130 from the plurality of mobile terminals based on various conditions. In one embodiment, for a video stream included in the broadcast video stream, the quality control system 256 may receive the video stream at an increased quality level. In this case, the broadcast video stream may be generated using the high-quality video stream so that a viewer a high-quality broadcast screen is provided to the user.

On the other hand, when a user excludes a video stream included in the broadcast video stream from a broadcast screen or replaces the video stream with another video stream, the quality control system 256 may receive the corresponding video stream at a decreased quality level. To this end, the quality control system 256 may send a request to increase or decrease the quality level of the video stream to the mobile terminal and transmit the video stream through the communication unit 210. In this case, the mobile terminal may increase or decrease the quality level of the video stream according to the request, for example, by adjusting the frame rate, bit rate, sampling rate, resolution, and the like.

Additionally or alternatively, the quality control system 256 may receive a video stream, which is displayed only in the preview area that is not included in the broadcast video stream at a decreased quality level. In this case, since the video stream not included in the broadcast video stream is received at a low quality, the load on the communication network and the real-time broadcast editing apparatus 130 may be reduced. In addition, the quality control system 256 may determine the qualities of video streams included in a broadcast video stream based on the ratio of the area occupied by each of the video streams in the broadcast screen. For example, the quality of the video streams may be determined in proportion to the ratio of the area occupied by each of the video streams in the broadcast screen.

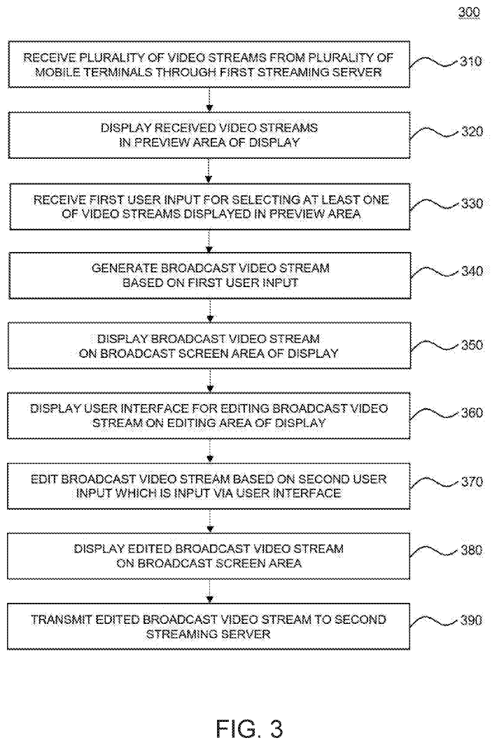

FIG. 3 is a flowchart showing a real-time broadcast editing method 300 according to an embodiment of the present disclosure. The real-time broadcast editing method 300 may be initiated by receiving a plurality of video streams from a plurality of mobile terminals through the first streaming server at step 310. Thereafter, the plurality of video streams being received may be displayed on the preview area of the display at step 320.

Thereafter, a first user input for selecting at least one of the plurality of video streams displayed on the preview area may be received at step 330. After the receiving the first user input, a broadcast video stream may be generated/rendered based on the first user input at step 340. In detail, the video streams selected by the user may be generated/rendered as a broadcast video stream according to a predetermined layout corresponding to the number of the selected video streams. The operation of generating/rendering the broadcast video stream will be described in detail with reference to FIGS. 4 to 6.

The generated/rendered broadcast video stream may be displayed on the broadcast screen area of the display at step 350. In order to edit the broadcast video stream displayed on the broadcast screen area, a user interface for editing a broadcast video stream may be displayed on the editing area of the display at step 360. Thereafter, the broadcast video stream may be edited based on a second user input that is input via the user interface at 370. Here, the editing of the broadcast video stream may include at least one of changing the layout in which the selected video streams are arranged, inserting subtitles into the broadcast video stream, inserting images into the broadcast video stream, inserting videos into the broadcast video stream, inserting sounds into the broadcast video stream, and applying filters to the broadcast video stream.

The edited broadcast video stream may be displayed on the broadcast screen area at step 380. In addition, the edited broadcast video stream may be transmitted to the second streaming server at step 390. The second streaming server may receive the edited broadcast video stream and transmit the received edited broadcast video stream to a plurality of viewing terminals.

FIG. 4 is a view illustrating an example of real-time broadcast editing according to an embodiment of the present disclosure. In FIG. 4, a real-time broadcast editing apparatus 400 is illustrated as a smart phone, but the present disclosure is not limited thereto, and the real-time broadcast editing apparatus 400 may be any electronic device provided with a communication module for network connection and configured to edit and render videos. The real-time broadcast editing apparatus 400 may edit a broadcast in real time through a first operation 402, a second operation 404, and a third operation 406. As shown in the first operation 402, the real-time broadcast editing apparatus 400 may output a plurality of video streams VS1, VS2, VS3, and VS4 received from a plurality of mobile terminals through a communication network such that the plurality of video streams VS1, VS2, VS3, and VS4 are displayed on a preview area 420 of a display 410.

Since four video streams are received, the preview area 420 may be divided into four areas 422, 424, 426, and 428 where the video streams VS1, VS2, VS3, and VS4 may be displayed. In one embodiment, the video streams VS1, VS2, VS3, and VS4 may refer to videos captured by the plurality of mobile terminals, respectively, which are streaming in real time. Although the video streams VS1, VS2, VS3, and VS4 being received in the first operation 402 are illustrated in a vertical mode, the present disclosure is not limited thereto, and when the mobile terminal captures a video stream in a horizontal mode, the video stream being received may be displayed in a horizontal mode on the preview area. That is, the preview area 420 is adaptively divided based on the number of the video streams being received and the capture mode (vertical mode/horizontal mode) to display the video streams being received. In one embodiment, the user may change the arrangement, size, and the like of the video streams displayed on the preview area 420 by touch input, a swiping input, or the like.

Thereafter, the user may select a video stream to be included in a broadcast screen among the video streams VS1, VS2, VS3, and VS4 displayed on the preview area 420 via a touch input or the like. For example, the user may select three video streams VS1, VS2, and VS3 as videos to be included in a broadcast screen among the four video streams VS1, VS2, VS3, and VS4 displayed on the preview area 420. As shown in the second operation 404, when the user selects video streams to be included in the broadcast screen, the selected video streams VS1, VS2, and VS3 are generated/rendered according to a predetermined layout so that a broadcast video stream 470 is displayed on a broadcast screen area 440 of the display 410.

The layout of the broadcast screen may be determined based on, for example, the number of selected video streams. In the second operation 404, since the user selects three video streams VS1, VS2, and VS3, the broadcast screen area 440 is divided into three sections 442, 444, and 446 such that the video streams VS1, VS2, and VS3 are displayed together. Alternatively, the layout of the broadcast screen may be determined or changed based on a user input.

In one embodiment, the real-time broadcast editing apparatus 400 may adjust the qualities of the video streams VS1, VS2, VS3, and VS4 being received from the mobile terminals based on the user selecting video streams to be included in the broadcast screen. For example, the real-time broadcast editing apparatus 400 may receive the video streams VS1, VS2, and VS3, which are to be included in the broadcast screen, from the mobile terminals by increasing the quality levels of the video streams VS1, VS2, and VS3, and may stop receiving the video stream VS4, which is not selected to be included in the broadcast screen. In addition, the real-time broadcast editing apparatus 400 may determine the quality levels of the video streams VS1, VS2, and VS3 based on a ratio of the area occupied by each of the video streams VS1, VS2, and VS3, which are included in the broadcast video stream 470 in the broadcast screen. For example, since the video stream VS1 occupies a larger area than the video streams VS2 and VS3 in the broadcast screen, the video stream VS1 may be received at a higher quality level than the video streams VS2 and VS3.

The real-time broadcast editing apparatus 400 may display a user interface 430 for editing the broadcast video stream 470 in the editing area 450 of the display 410. The user may edit each of the video streams VS1, VS2, and VS3 included in the broadcast screen or edit the entire broadcast video stream 470 using the user interface 430 displayed on the editing area 450. According to one embodiment, the user interface 430 may include an interface 432 for inserting an image into the broadcast video stream 470, an interface 434 for inserting a video stored in the real-time broadcast editing apparatus 400 or a video stream captured by the real-time broadcast editing apparatus 400, and an interface 436 for editing the broadcast video stream 470. When the user wishes to broadcast the broadcast video stream 470 displayed on the broadcast screen area 440 to viewers, the user may touch the “GO LIVE” button 460 to start streaming the broadcast video stream 470 to viewing terminals.

The user may change arrangement positions of the video streams VS1, VS2, and VS3 included in the broadcast video stream 470. For example, the arrangement of the video stream may be changed based on a user's swiping input or the like. Referring to the third operation 406, the user may drag the video stream VS3 through a swiping input 480 to swap output positions with the video stream VS2. When the user wishes to end the streaming during the real-time broadcast, the user may select the end button 462 to end broadcasting of the broadcast video stream 470.

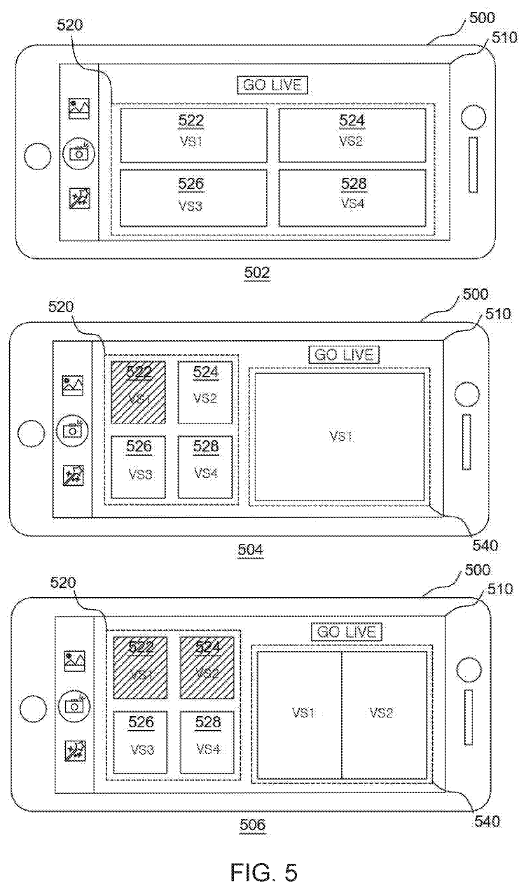

FIG. 5 is a diagram illustrating an example of real-time broadcast editing according to another embodiment of the present disclosure. According to the embodiment, a real-time broadcast editing apparatus 500 may edit a broadcast in real time through a first operation 502, a second operation 504, and a third operation 506. As shown in the first operation 502, the real-time broadcast editing apparatus 500 may output a plurality of video streams VS1, VS2, VS3, and VS4 being received from a plurality of mobile terminals through a communication network such that the plurality of video streams VS1, VS2, VS3, and VS4 are displayed on a preview area 520 of a display 510. Since four the video streams are received, the preview area 520 may be divided into four areas 522, 524, 526, and 528 in which the video streams VS1, VS2, VS3, and VS4 may be displayed. In one embodiment, the video streams VS1, VS2, VS3, and VS4 may refer to videos captured by the plurality of mobile terminals which are streaming in real time.

Thereafter, the user may select the video stream to be included in a broadcast screen among the video streams VS1, VS2, VS3, and VS4 displayed on the preview area 520 by a touch input. For example, the user may select one video stream VS1 as a video to be included in the broadcast screen among the four video streams VS1, VS2, VS3, and VS4 displayed on the preview area 520. As a result, as shown in the second operation 504, the preview area 520 and a broadcast screen area 540 are displayed together on the display 510, and the selected video stream VS1 is generated/rendered as a broadcast video stream and is displayed on the broadcast screen area 540 of the display 510.

In this case, the preview area 520 and the broadcast screen area 540 may be displayed together on the display 510, and the video stream VS1 included in the broadcast screen is displayed as a black and white screen or shaded screen such that the user may easily check the video stream included in the broadcast screen. In addition, an editing area including a user interface for editing a broadcast video stream may be displayed on the display 510 together with the preview area 520 and the broadcast screen area 540.

The user may additionally select video streams to be included in the broadcast screen among the video streams VS1, VS2, VS3, and VS4 displayed on the preview area 520 by a touch input, and the like. For example, the user may additionally select one video stream VS2 as a video to be included in the broadcast screen among the four video streams VS1, VS2, VS3, and VS4 displayed on the preview area 520. As a result, as shown in the third operation 506, the two selected video streams VS1 and VS2 may be generated/rendered as a broadcast video stream and displayed on the broadcast screen area 540.

In one embodiment, the real-time broadcast editing apparatus 500 may receive the video streams VS1 and VS2 included in the broadcast video stream at increased quality levels and receive the video streams VS3 and VS4 displayed only in the preview area 520 without being included in the broadcast video stream at decreased quality levels.

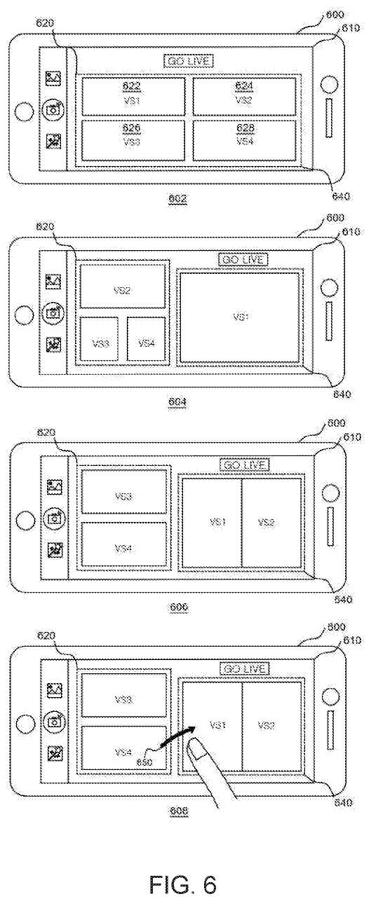

FIG. 6 is a view illustrating an example of real-time broadcast editing according to another embodiment of the present disclosure. According to one embodiment, a real-time broadcast editing apparatus 600 may edit a broadcast in real time through a first operation 602, a second operation 604, a third operation 606, and a fourth operation 608. As shown in the first operation 602, the real-time broadcast editing apparatus 600 may output a plurality of video streams VS1, VS2, VS3, and VS4 being received from a plurality of mobile terminals through a communication network such that the plurality of video streams VS1, VS2, VS3, and VS4 are displayed on a preview area 620 of a display 610. Since the four video streams are received, the preview area 620 may be divided into four areas 622, 624, 626, and 628 in which the video streams VS1, VS2, VS3, and VS4 may be displayed. In one embodiment, the video streams VS1, VS2, VS3, and VS4 may refer to videos captured by the plurality of mobile terminals which are streaming in real time.

Thereafter, the user may select the video stream to be included in a broadcast screen among the video streams VS1, VS2, VS3, and VS4 displayed on the preview area 620 by a touch input and the like. For example, the user may select one video stream VS1 as a video to be included in a broadcast screen among the four video streams VS1, VS2, VS3, and VS4 displayed on the preview area 620. As a result, as shown in the second operation 604, the preview area 620 and a broadcast screen area 640 are displayed together on the display 610, and the selected video stream VS1 is generated/rendered as a broadcast video stream and displayed on the broadcast screen area 640 of the display 610. As shown in FIG. 6, the selected video stream VS1 is removed from the preview area 620, and only the video streams VS2, VS3, and VS4 not included in the broadcast screen are displayed on the preview area 620.

The user may additionally select video streams to be included in the broadcast screen among the video streams VS2, VS3, and VS4 displayed on the preview area 620 through a touch input and the like. For example, the user may additionally select one video stream VS2 as a video to be included in the broadcast screen among the three video streams VS2, VS3, and VS4 displayed on the preview area 620. As a result, as shown in the third operation 606, the two selected video streams VS1 and VS2 may be generated/rendered as the broadcast video stream and displayed on the broadcast screen area 640.

In one embodiment, the real-time broadcast editing apparatus 600 may receive the video streams VS1 and VS2 included in the broadcast video stream by increasing the quality levels of the video streams VS1 and VS2, and receive the video streams VS3 and VS4 displayed only in the preview area 620 without being included in the broadcast video stream by decreasing the quality levels of the video streams VS3 and VS4.

The user may replace a video stream existing in the broadcast screen area 640 with a video stream existing in the preview area 620. For example, the user may replace the video streams based on a swiping input or the like. As shown in the fourth operation 608, the user may drag the video stream VS4 through a swiping input 650 to replace the video stream VS4 with the video stream VS1. In this case, the video stream VS1 may be displayed on the preview area 620, and the video stream VS4 may be displayed on the broadcast screen area 646. Thus, the video stream VS4 may be included in the broadcast video stream. In addition, the real-time broadcast editing apparatus 600 may receive the video stream VS4, which is added to the video stream, at an increased quality level, and receive the video streams VS1 displayed only in the preview area 620 while being excluded from the broadcast video stream at a decreased quality level.

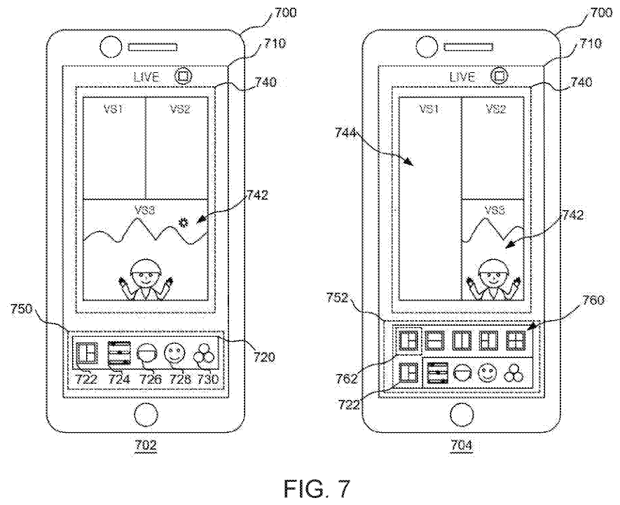

FIG. 7 is a view illustrating an example in which the layout of the broadcast video stream is changed using a user interface 720 according to an embodiment of the present disclosure. The user may change the layout of the broadcast video stream through a first operation 702 and a second operation 704 by a real-time broadcast editing apparatus 700. As shown in the first operation 702, the real-time broadcast editing apparatus 700 may display the user interface 720 for editing a broadcast video stream in an editing area 750 of a display 710. In one embodiment, the editing area 750 may be disposed below a broadcast screen area 740, and the user interface 720 may include a layout icon 722, an editing icon 724, an object correction icon 726, an image synthesizing icon 728, and a filter icon 730. The user interface 720 is not limited to the above-described detailed items and may also include various icons for performing operations, such as subtitle, image, and video insertion.

When the user wishes to change the layout of the broadcast video stream displayed on the broadcast screen, the user may change the layout by selecting the layout icon 722. As shown in the second operation 704, when the user selects the layout icon 722, pre-set layout templates may be displayed on an extended editing area 752, and one of the displayed layout templates is selected by the user to change the layout. In this case, the layout templates may be provided corresponding to the number of video streams included in the current broadcast screen.

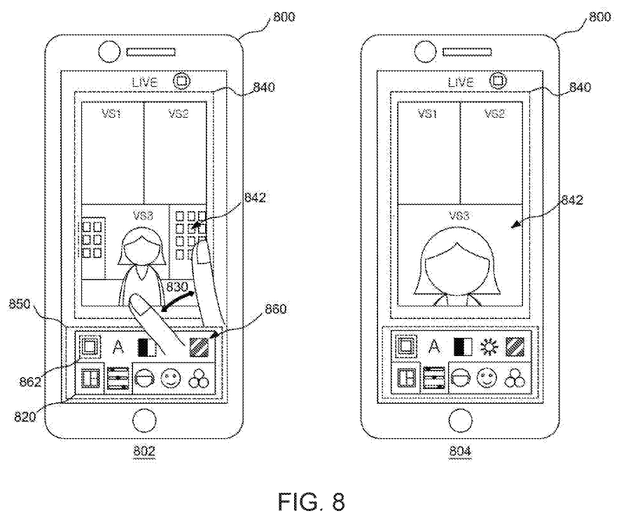

FIG. 8 is a view illustrating an example in which a screen of a video stream VS3 is enlarged using a user interface 820 according to an embodiment of the present disclosure. In one embodiment, a real-time broadcast editing apparatus 800 may display a user interface 860 of various detailed items for basic editing, such as subtitle insertion, screen magnification change, and the like, in an extended editing area 850. The user may change the screen magnification by selecting a screen magnification change icon 862.

In one embodiment, the user may change a screen magnification of a video stream included in the broadcast screen through a pinch gesture 830 and the like. For example, the user may enlarge the screen of a video stream VS3 through a first operation 802 and a second operation 804. As shown in the first operation 802 and the second operation 804, the user may enlarge the video stream VS3 by the pinch gesture 830 of spreading fingers. The enlarged video stream VS3 is displayed on a region 842 of a broadcast screen region 840 such that the user may check the magnification of the changed video stream VS3.

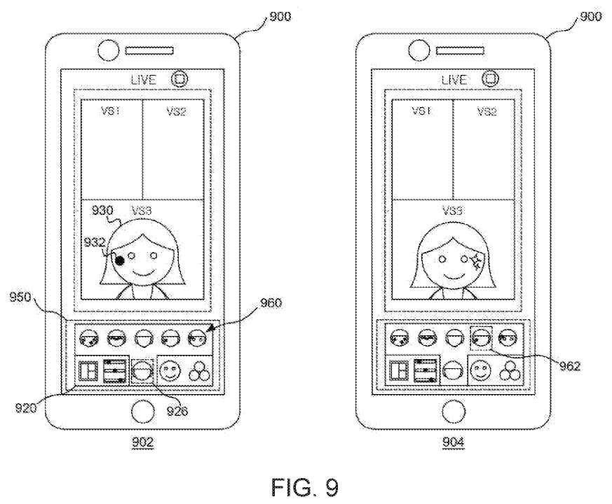

FIG. 9 is a diagram illustrating an example in which an object 930 included in a video stream VS3 is corrected using a user interface 920 according to an embodiment of the present disclosure. The user may correct the object 930 included in the selected video stream VS3 through a first operation 902 and a second operation 904 by a real-time broadcast editing apparatus 900. Before editing, the user may select a video stream VS3 to be edited among video streams VS1, VS2, and VS3 included in a broadcast screen area. Alternatively, the user may collectively correct objects included in all the video streams VS1, VS2, and VS3 included in the broadcast screen area.

In a state in which the video stream VS3 is selected, when the user selects an object correction icon 926, detailed icons 960 including a face correction icon, a blemish removal icon, and the like, may be displayed on an extended editing area 950. In this case, when the user selects a blemish removal icon 962 among the detailed icons 960, a skin blemish 932 of the object 930 included in the video stream VS3 may be removed.

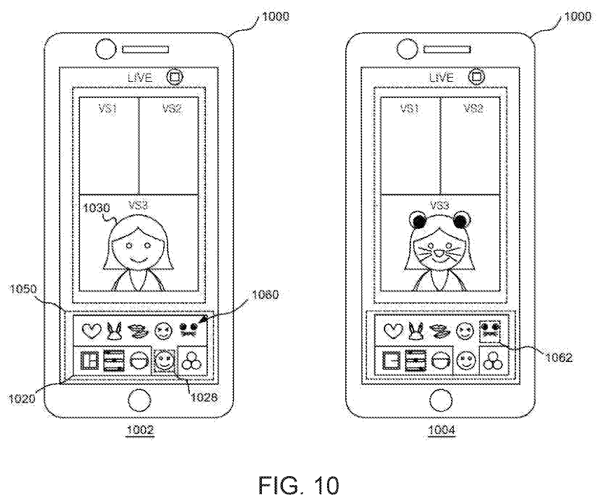

FIG. 10 is a diagram illustrating an example in which graphic elements are synthesized into a video stream VS3 using a user interface 1020 according to an embodiment of the present disclosure. The user may synthesize graphic elements into a selected video stream VS3 through a first operation 1002 and a second operation 1004 by a real-time broadcast editing apparatus 1000. Before editing, the user may select a video stream VS3 to be edited among video streams VS1, VS2, and VS3 included in a broadcast screen area. Alternatively, the user may collectively synthesize graphic elements into all the video streams VS1, VS2, and VS3 included in the broadcast screen area. Here, the graphic element may be a two-dimensional (2D) image, a third-dimensional (3D) image, a pre-rendered animation, a real time rendering graphics, or the like.

In a state in which the video stream VS3 is selected, when the user selects an image synthesizing icon 1028, detailed icons 1060 representing various images may be displayed on an extended editing area 1050. In this case, when the user selects a raccoon icon 1060, a raccoon image may be automatically synthesized into an object 1030 in the video stream VS3.

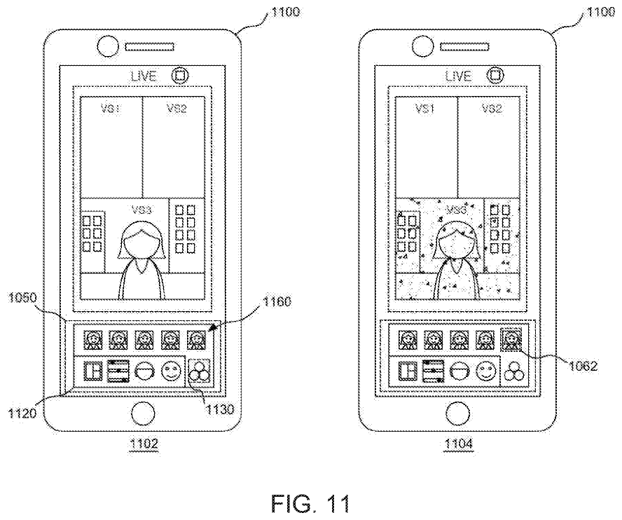

FIG. 11 is a view illustrating an example in which a filter is applied to a video stream VS3 using a user interface 1120 according to an embodiment of the present disclosure. The user may apply a filter to a selected video stream VS3 through a first operation 1102 and a second operation 1104 by a real-time broadcast editing apparatus 1100. Before editing, the user may select a video stream VS3 for which application of a filter is desired among video streams VS1, VS2, and VS3 included in a broadcast screen area. Alternatively, the user may apply a filter to all the video streams VS1, VS2, and VS3 included in the broadcast screen area.

In a state in which the video stream VS3 is selected, when the user selects a filter icon 1130, detailed icons 1160 corresponding to various filters representing effects of color, texture, and the like may be displayed on an extended editing area 1150. In this case, when the user selects a filter 1162 representing an effect of snowing, a snowing image may be automatically synthesized into the video stream VS3, resulting in the video stream VS3 captured on a sunny day appearing as if the video stream VS3 was captured on a snowy day.

Although the present disclosure has been described with reference to the exemplary embodiments, it should be understood by those skilled in the art that changes and modifications are possible without departing from the scope and sprit of the disclosure. In addition, the scope of the disclosure encompasses all modifications and equivalents that fall within the scope of the appended claims and will be construed as being included in the present disclosure.

1. A real-time broadcast editing method comprising:
receiving a plurality of video streams from a plurality of mobile terminals through a first streaming server;
displaying the plurality of video streams being received on a preview area of a display;
receiving a first user input for selecting at least one of the plurality of video streams displayed on the preview area;
displaying a user interface for editing a broadcast screen on an editing area of the display;
receiving a second user input via the user interface;
editing the selected at least one video stream based the first user input and the second user input, thereby generating an edited broadcast video stream;
displaying the edited broadcast video stream on a broadcast screen area of the display; and
transmitting the edited broadcast video stream to a second streaming server,
wherein the first streaming server has a streaming delay time less than a streaming delay time of the second streaming server, and
wherein the edited broadcast video stream is provided to a plurality of viewing terminals by the second streaming server.

2. The method of claim 1, wherein the editing of the selected at least one video stream based on the first user input and the second user input, thereby generating the edited broadcast video stream includes:
generating a broadcast video stream based on the first user input;
displaying the broadcast video stream on the broadcast screen area of the display; and
editing the broadcast video stream based on the second user input, thereby generating the edited broadcast video stream.

3. The method of claim 1, wherein the first streaming server is a Web Real-Time Communication (WebRTC) based streaming server, and
wherein the second streaming server is a Real Time Messaging Protocol (RTMP) based streaming server.

4. The method of claim 3, wherein the second streaming server converts the edited broadcast video stream using HTTP Live Streaming (HLS) or MPEG Dynamic Adaptive Streaming over HTTP (MPEG-DASH) and provides the converted edited broadcast video stream to the plurality of viewing terminals.

5. The method of claim 1, wherein qualities of the plurality of video streams received from the plurality of mobile terminals are determined based on the first user input.

6. The method of claim 5, wherein the video stream selected by the first user input is received at an increased quality level.

7. The method of claim 5, wherein the video stream not selected by the first user input is received at an decreased quality level.

8. The method of claim 2, wherein the generating of the broadcast video stream based on the first user input includes:
determining a layout in which the video streams selected by the first user input are arranged;
determining quality of each of the selected video streams based on an area ratio occupied by each video stream in the layout; and
receiving the selected video streams with the determined respective qualities from the plurality of mobile terminals and generating a broadcast video stream according to the layout.

9. The method of claim 2, wherein the editing of the broadcast video stream includes at least one of:
changing a layout in which the selected video streams are arranged;
inserting a subtitle into the broadcast video stream;
inserting an image into the broadcast video stream;
inserting a video into the broadcast video stream;
inserting sound into the broadcast video stream; and
applying a filter to the broadcast video stream.

10. The method of claim 1, wherein the preview area, the broadcast screen area, and the editing area are displayed together on the display; and
wherein the selected video stream is displayed on the broadcast screen area and not displayed on the preview area.

11. A real-time broadcast editing system comprising:
a data receiver configured to receive a plurality of video streams from a plurality of mobile terminals through a first streaming server;
a display configured to display a preview area, a broadcast screen area, and an editing area;
an input device configured to receive a user input;
a controller configured to generate a broadcast video stream and edit the generated broadcast video stream; and
a data transmitter configured to transmit the edited broadcast video stream to a second streaming server,
wherein the controller is configured to:
display the plurality of video streams being received on the preview area;
receive a first user input for selecting at least one of the plurality of video streams displayed on the preview area;
display a user interface for editing a broadcast screen on the editing area;
receive a second user input, which is input via the user interface, from the input device;
edit the selected at least one video stream based on the first user input and the second user input and generate an edited broadcast video stream; and
display the edited broadcast video stream on the broadcast screen area,
wherein the first streaming server has a streaming delay time less than a streaming delay time of the second streaming server, and
wherein the edited broadcast video stream is provided to a plurality of viewing terminals by the second streaming server.
